(19) United States
(12) Patent Application Publication
(10) Pub. No.: US 2026/0346576 A1
(43) Pub. Date: Nov. 5, 2026

(54) METAL PIPE WITH A PLASTIC COATING

(71) Applicant: TDC INTERNATIONAL AG, Luzern (CH)

(72) Inventors: Patrick GODBOUT, Luzern (CH); Ruirui WELKER, Luzern (CH); Daniel WELKER, Luzern (CH)

(21) Appl. No.: 19/105,694

(22) PCT Filed: Aug. 23, 2023
(86) PCT No.: PCT/EP2023/073152

§ 371 Date: Feb. 21, 2025

(30) Foreign Application Priority Data
Aug. 23, 2022 (DE) 10 2022 121 332.3

(51) Int. Cl. B32B 15/092; B32B 1/08; B32B 5/12; B32B 15/18

(52) U.S. Cl. CPC B32B 15/092; B32B 1/08; B32B 5/12; B32B 15/18; B32B 2250/02; B32B 2255/06; B32B 2255/26; B32B 2262/101; B32B 2307/20; B32B 2307/54; B32B 2307/7265; B32B 2597/00

(57) ABSTRACT

The current disclosure describes a pipe having a dielectric coating comprising a corrosion protection layer, an adhesion layer, a thermoplastic coating and a protective sheathing that is reinforced with a glass fibre surrounding the thermoplastic coating. The protective sheathing is formed by several layers of glass fibre mat or glass fibre fabric or a combination of both, the layers being applied to the thermoplastic coating by a wet-on-wet process using a vinyl ester, polyester or epoxy resin. The dielectric coating is optionally between 8 and 10 mm thick and provides a dielectric breakdown protection of more than 50 kV.

According to one aspect, the invention relates to a metal pipe with a plastic sheath, in particular with a thermoplastic coating and a fibre-reinforced protective sheathing enclosing the thermoplastic coating.

It is known to provide buried steel pipes for the transport of liquid or gaseous media with a relatively thin coating of plastic, preferably polypropylene, polyethylene, fusion-bonded epoxy (FBE) or polyurethane, for example to prevent corrosion of the metallic pipe material. Such layers of polypropylene, polyethylene, FBE or polyurethane ensure excellent corrosion protection on the one hand, as the earth moisture and/or other electrolytes cannot come into contact with the metallic pipe material. However, layers of polypropylene, polyethylene, FBE or polyurethane have only a relatively low mechanical strength. To protect the polypropylene, polyethylene, FBE or polyurethane coating from undesired mechanical abrasion, it is known to additionally provide the pipe with a fibre cement coating or a fibre reinforced plastic (GRP) coating.

The invention addresses the problem of improving a metal pipe with a plastic coating.

According to the invention, this problem is solved by a metal pipe with a dielectric coating that comprises a corrosion protection layer, an optional thermoplastic coating and an outer sheathing made of fibre-reinforced thermosetting polymer (fiber-reinforced duromer, for instance fibre-reinforced epoxy-resin or fibre-reinforced polyester resin) surrounding the corrosion protection layer or the thermoplastic coating. The outer sheathing comprises several layers of fibre-reinforced plastic, preferably glass fibre-reinforced plastic (GRP). The fibres of the fibre-reinforced plastic layers preferably are glass fibres in the form of rovings, glass fibre fabric, multiaxial fabric, UD fabric, glass fibre mat or a combination of these. Preferably, the layers are applied to the corrosion protection layer or the thermoplastic coating in a wet-on-wet process using a vinyl ester, polyester or epoxy resin that is reinforced with the fibres. In a preferred embodiment a metal pipe is provided with a corrosion protection layer made of FBE and an outer sheathing made of fibre-reinforced thermosetting polymer is directly applied to the FBE layer; i.e. no intermediate thermoplastic coating is provided.

The dielectric coating is between 8 and 10 mm thick and provides a dielectric breakdown protection of more than 50 kV. Dielectric breakdown is measured with an electric conducting sleeve wrapped around the outer protective shielding and applying a testing voltage between the metal pipe and the electric conducting sleeve.

Tested samples with a dielectric coating having a thickness of 8.7 mm had a dielectric strength of 62 KV, i.e. a dielectric breakdown occurred at 62 kV during a test wherein an alternating testing voltage is increased in increments of 4 kV/30 sec to 5 k/30 sec. The dielectric coating of the tested samples was composed of thermoplastic coating made of PE (polyethylene) with thickness about 3.1 mm and a glass fibre reinforced protective sheathing made of cross-wound glass fibres, the GRP protective sheathing having a thickness of approximately 5.6 mm.

Instead of glass fibres, other electrically insulating fibres can also be used, in particular polypropylene (PP) or polyester fibres.

The combination of corrosion protection layer and outer protective sheathing preferably is configured to meet the following corrosion protection properties in accordance with ISO 21809-1:2018, Annexes H and L and ISO 62:2008, Procedure 1:
a cathodic infiltration in accordance with ISO 21809-1:2018, Annex H during a test.
   with a flaw hole with a diameter of 6.5 mm,
   at a test voltage of 3.5 volts,
   at a test temperature of 65 °C and
   a test duration of 24 hours
of less than 6 mm, preferably less than 4 mm, particularly preferably less than 2 mm, and/or
a cathodic infiltration in accordance with ISO 21809-1:2018, Annex H during a test.
   with a flaw hole with a diameter of 6.5 mm,
   at a test voltage of 3.5 volts,
   at a test temperature of 65 °C and
   a test duration of 168 hours
of less than 6 mm, preferably less than 4 mm and particularly preferably less than 2 mm
   and/or
no loss of adhesion in an immersion test of 1120 hours duration with 80 °C hot water according to ISO 21809-1:2018, Annex L.

The invention includes the insight that the corrosion protection effect of plastic sheathings known in the prior art, e.g. of polypropylene, polyethylene, fusion-bonded epoxy (FBE) or polyurethane, is already excellent, but can be further improved, in particular with regard to a long-lasting protective effect, by supplementing or replacing a thermoplastic coating known per se with a protective sheathing which not only offers improved mechanical protection, but also offers considerably improved corrosion protection in combination with the corrosion protection layer and an optional thermoplastic coating.

This applies in particular when the layer thickness of the protective sheathing is equal to or greater than the layer thickness of a conventional thermoplastic coating and the layer thickness of the protective sheathing is preferably more than 2.5 mm, preferably more than 4 mm. Protective sheathings with a layer thickness between 3 mm and 5 mm are preferred.

Surprisingly, it has been found that the protective coating improves the corrosion protection effect of the corrosion protection layer and, if applicable, of the thermoplastic coating itself, because the protective coating is able to prevent infiltration of the corrosion protection layer even where, for example, moisture and/or other electrolytes can reach the corrosion protection layer directly, as is the case, for example, in a test for resistance to cathodic infiltration in accordance with ISO 21809-1:2018, Appendix H.

The improved corrosion protection properties of the metal pipe with a corrosion protection layer, optional thermoplastic coating and a protective sheathing made of fibre-reinforced plastic is, according to the applicant's understanding, due to the fact that at least some of the fibres of the protective sheathing were under tension while being wound around the metal tube. Tensile forces in the order of up to 0.5 of the fibre's linear density (measured in tex: grams/1000 m) have been shown to be beneficial with glass fibres. So if the linear density of a roving is, for example, 2000 tex (i.e. 2000 grams per 1000 metres), the tensile force can be up to 1 kg—or more precisely: 9.81 Newtons. The tensile force during winding results in a force directed radially inwards, which can prevent the formation of hydrogen bubbles due to electrolytic corrosion—and thus the infiltration of the corrosion protection layer. This is especially true if the radially inward force causes a pressure that is greater than the pressure prevailing in the hydrogen bubbles that form, so that hydrogen bubbles with gaseous hydrogen (H₂) do not form in the first place.

Corresponding tests were carried out to prove the corrosion protection properties.

For the tests carried out in accordance with ISO 21809-1:2018, Annexes H and L, specimens were used, each of which was a 150 mm section of steel pipe conforming to DN 250 with the following coating:
a 3LPE coating with a thickness of 3 mm, comprising
   an epoxy powder coating (Fusion Bonded Epoxy; FBE) as corrosion protection layer
   an adhesive layer in the form of a copolymer and
   a polyethylene layer as thermoplastic coating,
and
a GRP sheathing with a thickness of 5.5 mm as a protective sheathing.

Preferred is a metal pipe that has a weight change of less than 20 grams per m² outer surface when tested for water absorption in accordance with ISO 62:2008, method 1 (water temperature 23 °C) over a test period of 1050 hours with a specimen in the form of a coated steel pipe DN 250 with 25 mm length.

For testing for water absorption analogous to ISO 62:2008, specimens were used, each of which was a 25 mm long section of a steel pipe according to DN 250 with the following coating:
a 3LPE coating with a thickness of 3 mm, comprising
   an epoxy powder coating (Fusion Bonded Epoxy; FBE) as corrosion protection layer
   an adhesive layer in the form of a copolymer and
   a polyethylene layer as thermoplastic coating,
and
a GRP sheathing with a thickness of 5.5 mm as a protective sheathing.

The specimens for the test for water absorption analogous to ISO 62:2008 thus only differed in length from the specimens for the tests according to ISO 21809-1:2018, Appendices H and L.

The test according to ISO 62:2008, “Method 1” was carried out at a water temperature of 23 °C and over different immersion durations of 24 h (hours), 48 h, 94 h, 208 h, 573 h, 742 h, 935 h and 1051 h, i.e. the first specimens were removed from the water bath after 24 hours of immersion and the last specimens after 1051 hours.

The samples were dried at 50 °C for six days before immersion and weighed to the nearest tenth of a gram.

After removal from the water bath, adhering water was removed and the sample was weighed again. The water absorption was determined from the difference in mass before immersion in the water bath and after removal from the water bath.

Preferably, at least one layer of the protective sheath is formed by cross-wound textile glass rovings, glass fibre fabrics, multiaxial fabrics, UD fabrics or glass fibre mats or a combination of these glasses. Cross-wound means that the glass fibres are applied to the tube by winding, one (glass) layer with a first winding sense and a second (glass) layer with a winding sense opposite to this winding sense. The two glass layers do not cross each other.

It has been found that a protective sheathing with cross-wound textile glass rovings, glass fibre fabrics, multiaxial fabrics, UD scrims or glass fibre mats further improves the corrosion protection effect compared to other glass fibre reinforced plastic sheathings.

Preferably, at least the outermost layer of the protective sheathing—here called the outer layer—is cross-wound. Such an outer layer offers the advantage that the pipe provided with the protective sheathing can be driven in any direction. In known pipes, there is typically one direction in which there is a greater risk of damage to the protective coating than in the opposite direction. With regard to the corrosion protection effect, it should be added that wrapping the metal pipe with fibres that are under tension during winding is particularly effective if the fibres that are under tension during winding form the outer layer and the entire protective coating is produced wet-in-wet. In this case, the tensile force on the outer fibres means that the radially inward force resulting from the tensile force can also act directly on fibres further inwards, since the resin forming the matrix of the protective sheathing has not yet cured—at least not completely.

The fact that the fibres of the protective sheathing have different pitches or different winding directions—i.e. cross-wound—supports the anti-corrosion properties.

Preferably, the glass fibres wound onto the tube are provided in the form of rovings, especially wound rovings, glass fibre fabrics, multiaxial fabrics, UD fabrics or glass fibre mats.

In addition to the fibres and the synthetic resin forming the matrix, the protective sheathing can also contain chemically reinforcing and/or inert additives with reinforcing properties, such as quartz sand.

The thermoplastic coating provided according to some embodiments—i.e. optionally—is preferably applied directly to the metal tube. The metal pipe is preferably a steel pipe.

Furthermore, it is preferred if the protective sheathing has an approximately continuously decreasing thickness at the longitudinal ends of the pipe over a length of approximately 100 mm maximum half a meter, whereby the protective sheathing is provided with a peel ply on its outer side in its area of decreasing thickness. This measure helps to ensure that the longitudinal ends of the pipes do not have to be ground before the protective sheathing is applied on site.

Furthermore, it is preferred if the layers of the fibre-reinforced protective sheathing formed by glass fibre mats or glass fibre fabric—with the exception of the outer coatings—are formed by glass fibre webs which are wound around the pipe in such a way that the edges of a respective glass fibre web partially overlap. The result is that each layer of the protective sheathing has no gaps and is self-contained.

According to a particularly preferred embodiment, the protective sheathing has an inner layer or two inner layers, each of which is formed by a glass fibre mat or glass fibre fabric with a grammage of between 300 and 500 g/m², preferably of about 450 g/m². The inner layer or inner layers are those layers of the protective sheathing that are closest to the thermoplastic coating.

Layers of winding rovings and axial glass fibres, in particular multiaxial fabrics or UD fabrics, are particularly preferred, i.e. layers of winding rovings and axial glass fibres are applied alternately. The required material proportions of reactive resin in relation to glass fibres can vary depending on the requirements. Preferably, about 600 g/m² of winding roving is used as reinforcement in the radial direction, and about 400 g/m² in the axial tube direction are processed alternately.

According to a further advantageous embodiment, axial glass fibres, in particular multiaxial fabrics or UD fabrics, are applied in layers.

It is also possible to use chopped glass fibres (cut roving) or chemically reinforcing and/or inert additives with reinforcing properties, such as quartz sand between the individual glass layers.

According to a further advantageous embodiment, several individual locally limited protective sheathings in the form of ribs or skids are provided, which serve as spacers to a jacket tube during installation of the pipe and thus provide protection of the thermoplastic sheathing against mechanical loads.

Combinations of a protective sheathing extending over the length of a tube and shorter ribs or skids are also preferred.

The inner layer or layers are preferably formed by wound glass fibre webs that have a width of less than 35 cm. For example, if the width of the glass fibre web is 30 cm and it is wound around the tube with an overlap of 3 cm, the resulting winding has a pitch of 27 cm.

Furthermore, it is preferred if the protective sheathing comprises at least one middle layer or two middle layers, each of which is formed by a glass fibre mat or glass fibre fabric with a grammage (weight per unit area) of between 800 g/m² and 1200 g/m², and preferably with a grammage of about 1000 g/m², e.g. 1030 g/m². The middle layer or layers of the protective sheathing are located in the radial direction of the tube between the at least one inner layer and the outer layer.

The at least one middle layer of the protective sheathing is preferably formed by a wound glass fibre web with a maximum width of 40 cm. With an overlap of about 5 cm, this results in a pitch of 35 cm per winding.

The thermoplastic coating of the pipe is preferably formed by polyethylene, polypropylene or polyurethane.

The pipe preferably has a nominal diameter between 100 and 2500 mm and the thickness of the protective sheathing is preferably between 4 and 8 mm, particularly preferably about 6 to 7 mm.

Another aspect of the invention relates to pipe joints that are made on site, i.e. when the pipes are laid, and which also have to be coated after the weld has been made. As a corrosion protection layer, it is preferred to spray a polyurethane layer over the entire surface of the weld seam area up to and beyond the factory-made corrosion protection layer. After this layer has cured, the surface is roughened, preferably by sandblasting, and a glass-fibre reinforced protective sheathing is applied. This protective sheathing is formed by several layers of glass fibre mat or glass fibre fabric or a combination of both, the layers being applied to the polyurethane coating by a wet-on-wet process using a vinyl ester, polyester or epoxy resin. The thickness of this on-site protective sheathing is preferably between 3 and 8 mm, particularly preferably about 5 mm.

Further features and properties as well as variants of pipes according to the invention and pipe assemblies according to the invention can be found in the following description of embodiment examples. The invention will thus be explained in more detail on the basis of the following exemplary embodiments. Of the figures illustrating the embodiments, the individual figures show the following:

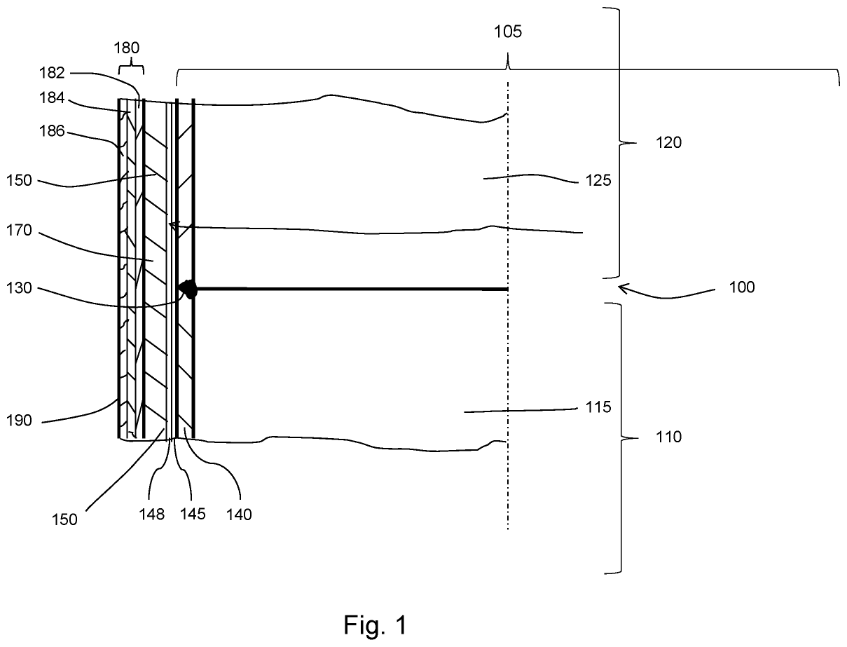

FIG. 1: is a sectional longitudinal section through a pipe with a metal tube and a dielectric coating comprising a thermoplastic coating and a fibre-reinforced protective sheathing surrounding the thermoplastic coating;

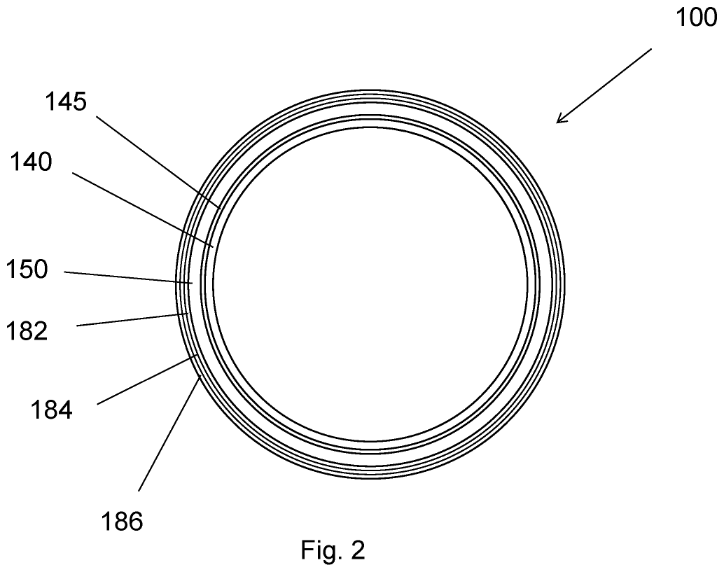

FIG. 2: shows an example of a cross-section through a pipe with a dielectric coating according to the invention; and

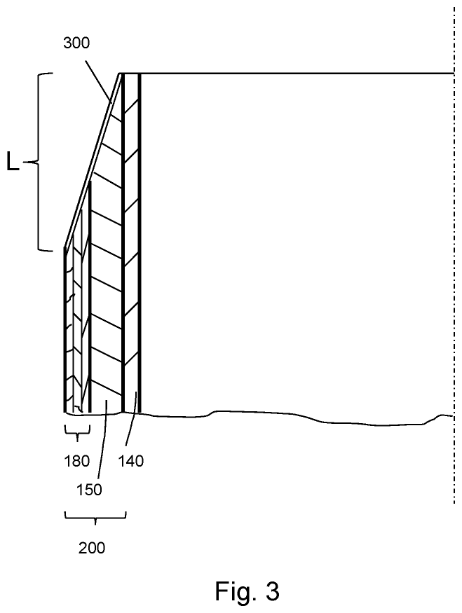

FIG. 3: shows a longitudinal end of a pipe with a protective sheathing of decreasing thickness towards the longitudinal end;

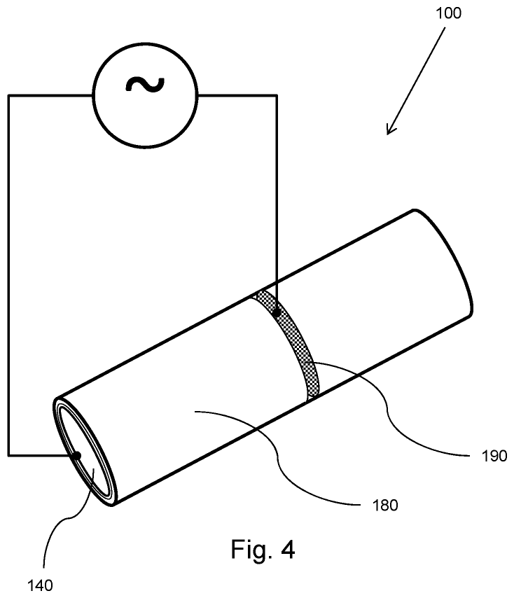

FIG. 4: illustrates in a schematic representation the testing set-up for testing the dielectric breakthrough resistance of the dielectric coating;

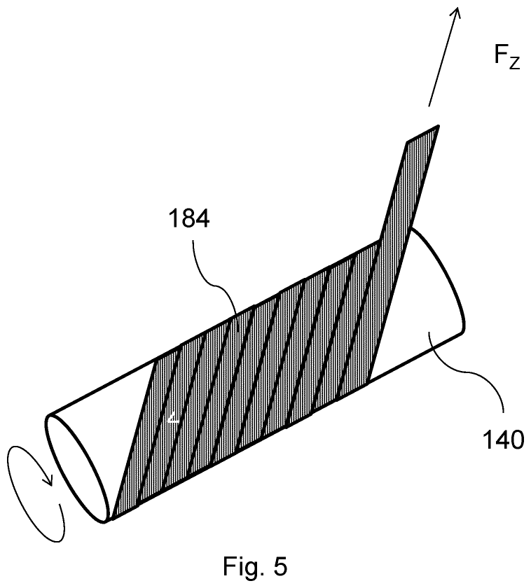

FIG. 5: illustrates the application of the fibres of the protective sheathing with a first winding sense, where the fibres are under tension and the tensile force is F_{Z};

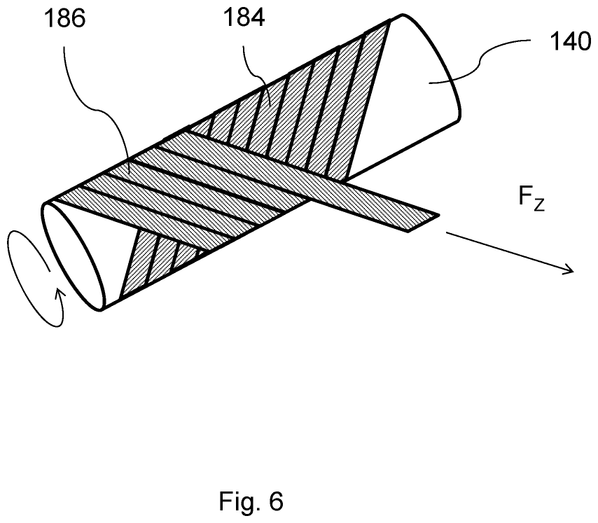

FIG. 6: illustrates the application of the fibres of the protective sheathing with a second winding sense, the fibres being under tension and the tensile force being F_{Z}; and

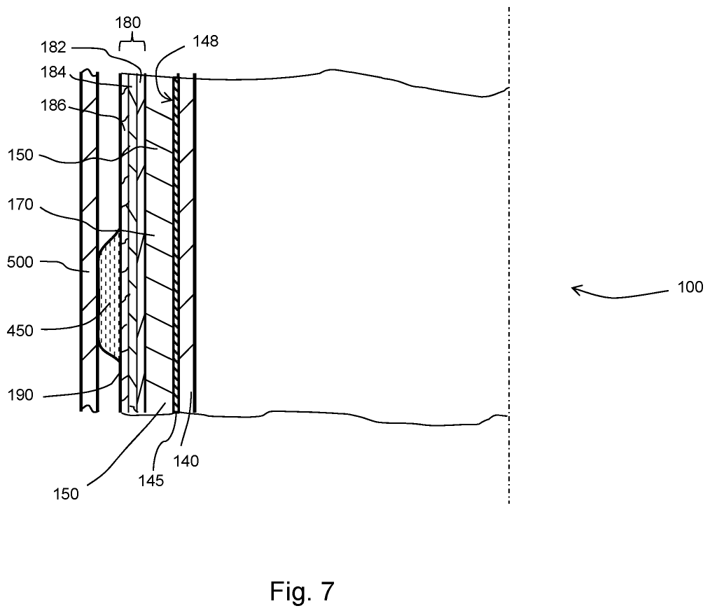

FIG. 7: shows a longitudinal section through a pipe section with a pipe with a thermoplastic coating and a fibre-reinforced protective sheathing enclosing the thermoplastic coating as well as a sliding skid applied thereto as a spacer to a casing pipe.

FIG. 1 is a sectional longitudinal view of a pipe 100 formed by a metal tube 105, for example a steel tube, a thermoplastic coating 150 applied thereto, and a fibre-reinforced protective sheathing 180 surrounding the thermoplastic coating 150. The thermoplastic coating 150 is optional.

In the illustrated example, the tube 105 has a nominal diameter of 500 mm and is composed of a plurality of spiral welded pipe sections 110 and 120 joined together by a weld 130.

A wall 140 of the metal tube 105 of pipe 100 is made of steel and is provided with a fusion bonded epoxy (FBE) layer 145 serving as a corrosion protection layer and an optional thermoplastic coating 150 made of polyethylene (PE). An adhesion layer 148 is preferably provided between the fusion bonded epoxy (FBE) layer 145 and the thermoplastic coating 150 to improve the bonding of the thermoplastic coating 150 to the fusion bonded epoxy (FBE) layer 145. The adhesion layer 148 preferably is made from a copolymer.

According to a preferred embodiment, the fibre-reinforced protective sheathing 180 is directly applied to the fusion bonded epoxy (FBE) layer 145.

In the area of the weld seam 130, the thermoplastic coating 150 is interrupted and replaced by a shrink sleeve or a repair tape 170 made of polyethylene to bridge the interruption of the thermoplastic coating 150. In order to be able to weld the pipe sections 110 and 120 together, the thermoplastic coating 150 at the ends 115 and 125 of the pipe sections 110 and 120 is removed before the pipe sections 110 are welded together. After the welding process, the thermoplastic coating 150 is replaced by the shrink sleeve or the repair tape 170 made of polyethylene.

As is apparent from FIG. 1, the thickness of the fibre reinforced protective sheathing 180 is equal to or slightly greater than the thickness of the thermoplastic coating 150. The thickness of the fibre reinforced protective sheathing 180 can be approximately 5 mm. For example, the FBE layer 145 and the thermoplastic coating 150 together may have a thickness between 2.5 mm and 4.5 mm and the protective sheathing 180 has a thickness between 5.5 mm and 8 mm, for example 6 mm to 7 mm.

In case no thermoplastic coating 150 is provided, i.e. when the fibre reinforced protective sheathing 180 is directly applied to the FBE layer 145, the fibre reinforced protective sheathing 180 preferably has a thickness between 7 mm and 10 mm, for example 8 mm to 9 mm

The thermoplastic coating 150 and the fibre reinforced protective sheathing 180 are forming a dielectric coating 200 the can withstand a breakthrough voltage of at least 50 kV and preferably of more than 60 kV, even more preferred of more than 75 kV. A schematic testing set-up for determining the breakthrough voltage is illustrated in FIG. 4. The test procedure can correspond to ASTM D149-09.

The dielectric strength was tested on a DN250 pipeline section with a DN250 inner metal tube 105. During the test, the alternating voltage was increased in increments of 4 kV/30 sec to 5 kV/30 sec till a voltage breakdown between the metal tube und the electric conducting sleeve was realized. The material thicknesses tested where “typical” factory applied processes. To avoid tracking issues during the testing the tested pipe sections were submerged in a 250 liter vessel filled with transformer oil. Five samples were tested with good repeatability of the breakdown voltage

The protective sheathing 180 can have one or two inner layers 182 and one or two middle layers 184 and an outer layer 186.

Each of these layers is formed by glass fibre reinforced plastic (GRP), namely glass fibres wrapped around the pipe 100 and embedded in a resin matrix of vinyl ester resin, polyester resin or epoxy resin, i.e. a thermosetting polymer material.

The fibre webs that form the inner layer 182 or the inner layers 182 as well as the fibre webs that form the middle layer 184 or the middle layers 184 are wound on the pipe 100 in such a way that the two edges of a respective fibre web overlap by about two to five centimeters.

In the exemplary embodiment, the inner layer or layers 182 are made using a glass fibre mat having a grammage of about 450 g/m², while the middle layer or layers 184 are made using a glass fibre mat having a grammage of about 1030 g/m².

Unlike the inner layer 182 or inner layers 182 and the middle layer 184 or middle layers 184, the outer layer 186 is not wound in a uniform direction for each layer, but is cross-wound, i.e. the outer layer is formed by two fibre webs which are wound in opposite directions and cross over each other. This is illustrated in FIGS. 5 and 6. During winding, the fibres are under tension and the respective tensile force F_{Z} preferably has a magnitude of up to 0.5 of the linear density of the glass fibres—more precisely: up to half of the value that results when the tex value according to ISO 1144 is multiplied by 1000 (metres) and the resulting mass is converted into a force (a mass of 1 kg corresponds to a force of 9.81 Newtons).

All layers 182, 184 and 186 are applied wet-on-wet to the thermoplastic coating 150 or the FBE layer 145, i.e. each successive layer is applied to the preceding layer before the resin forming the resin matrix of the preceding layer has cured. In this way, the layers 182, 184 and 186 are intimately bonded together.

The glass content of the protective sheathing 180 is at least 35 mass percent, i.e. the resin content is less than 65 percent.

FIG. 2 shows an example of a cross-section through a pipe 100 sheathed according to the invention.

FIG. 3 shows a longitudinal end of a pipe 100 with a protective sheathing 180 whose thickness decreases along a length L towards the longitudinal end of the pipe 100. The protective sheathing 180 is provided with peel ply 300 on its outer side in the region L of decreasing thickness. Both measures—the decreasing thickness as well as the peel ply 300—contribute to the fact that the longitudinal ends of the pipes 100 can be easily joined together by welding and that after welding of the tubes a protective sheathing can be built up in the area of the weld seam in a simple manner. The peel ply 300 ensures that the original protective sheathing does not have to be ground in the area of the pipe ends. The decreasing thickness of the original protective sheathing leads to an approximately continuous transition from the original protective sheathing to the local protective sheathing created after welding the tubes 105 in the area of the weld seam.

FIG. 4 illustrates in a schematic representation the testing set-up for testing the dielectric breakthrough strength of the dielectric coating 200. For measuring dielectric breakdown an electric conducting sleeve 190 is wrapped around the outer protective sheathing 180 and an alternating testing voltage is applied between the metallic wall 140 of the metal tube 105 and the electric conducting sleeve 190. The breakthrough voltage can be determined according to ASTM D 149-09. The frequency of the alternating testing voltage is between 50 Hz and 60 Hz. During the test, the alternating voltage is increased every 30 seconds in increments of between 4 kV and 5 kV, i.e. 4 kV/30 sec or 5 kV/30 sec.

Tested samples with a dielectric coating having a thickness of 8.7 mm had dielectric strength of 62 KV, i.e. a dielectric breakdown occurred at 62 kV during the test illustrated above. The dielectric coating of the tested samples was composed of thermoplastic coating made of PE (polyethylene) with thickness about 3.1 mm and a glass fibre reinforced protective sheathing made of cross-wound glass fibres, the GRP protective sheathing having a thickness of approximately 5.6 mm.

FIG. 7 shows a longitudinal section through a pipe section with a pipe 100 with a thermoplastic coating 150 and a fibre-reinforced protective sheathing 180 surrounding the thermoplastic coating 150 as well as a skid 450 applied thereto as a spacer to a jacket pipe 500. The jacket tube 500 serves here as an outer protection into which the pipe 100 is pushed together with the thermoplastic coating 150, protective sheathing 180 and skids 450 applied thereto. Preferably, several skids 450 are provided with a longitudinal distance from each other.

### LIST OF REFERENCE SIGNS

100 Pipe
105 metal tube
110, 120 pipe section
115, 125 longitudinal end of a pipe
130 weld seam
140 wall of the metal tube
145 FBE layer
148 adhesive layer
150 thermoplastic coating
170 repair tape
180 protective sheathing, GRP sheathing
182 inner layer of the protective sheathing
184 middle layer of the protective sheathing
186 outer layer of the protective sheathing
190 electric conducting sleeve
200 dielectric coating
300 peel ply
450 skid
500 jacket tube

1. A metal pipe, comprising:
a dielectric coating that comprises a corrosion protection layer and a protective sheathing made of a fibre-reinforced thermosetting plastic, the protective sheathing wrapping the corrosion protection layer and a thermoplastic coating, wherein the protective sheathing is formed by a plurality of layers of fibre-reinforced plastic, wherein the dielectric coating is between 8 and 10 mm thick and provides a dielectric breakdown strength of more than 50 kV.

2. The metal pipe according to claim 1, wherein the protective sheathing is directly applied on the corrosion protection layer, and wherein the corrosion protection layer is made of fusion-bonded epoxy (FBE).

3. The metal pipe according to claim 1, wherein the dielectric coating further comprises an adhesion layer, wherein the adhesion layer is arranged between the corrosion protection layer and the thermoplastic coating.

4. The metal pipe according to claim 1,
wherein the protective sheathing has a layer thickness of at least 2.5 mm, wherein the plurality of layers of the protective sheathing comprise textile glass fibres, and wherein the plurality of layers are applied to the thermoplastic coating in a wet-on-wet process using a vinyl ester, polyester, or epoxy resin, and
wherein a combination of the corrosion protection layer, the thermoplastic coating, and the protective sheathing (180) is configured to meet at least one of the following corrosion protection properties:
a cathodic infiltration of less than 6 mm, using the following test conditions:
a flaw hole with a diameter of 6.5 mm,
a test voltage of 3.5 volts,
a test temperature of 65 °C, and
a test duration of 24 hours, and/or
a cathodic infiltration of less than 6 mm, using the following test conditions:
a flaw hole with a diameter of 6.5 mm,
a test voltage of 3.5 volts,
a test temperature of 65 °C, and
a test duration of 168 hours, and/or
no loss of adhesion in an immersion test of 1120 hours duration with 80 °C hot water.

5. The metal pipe according to claim 4, wherein the combination of the corrosion protection layer, the thermoplastic coating, and the protective sheathing is configured to have a weight change of less than 20 grams per m² outer surface when tested for water absorption (with the water at a temperature of 23 °C) over a test period of 1050 hours with a specimen in a form of a coated steel pipe with 25 mm length.

6. The metal pipe according to claim 1, wherein the metal pipe is a steel pipe with a steel tube covered by the dielectric coating.

7. The metal pipe according to claim 6, wherein the corrosion protection layer is applied directly to the steel tube.

8. The metal pipe according to claim 6, wherein at least two layers of the plurality of layers of the protective sheathing are formed by cross-wound textile glass fibres, and wherein the at least two layers are wound under tension with a tensile force F_{Z} around the steel pipe, the tensile force being adjusted as a function of the linear fibre density.

9. The metal pipe according to claim 8, wherein the at least two layers of the protective sheathing are two outer layers of the protective sheathing, wherein the two outer layers are wound around the steel pipe under tension and with opposite winding directions and/or opposite pitches.

10. The metal pipe according to claim 8, wherein the tensile force F_{Z} is at most half a fibre's tex value multiplied by 1000 meters and converted into a force in newtons.

11. The metal pipe according to claim 1, wherein the protective sheathing is provided with peel ply on an outer side of the protective sheathing at longitudinal ends of the metal pipe over a length between 100 mm and 500 mm.

12. The metal pipe according to claim 1, wherein at least some of the plurality of layers of the fibre-reinforced protective sheathing are made of glass fibre mats or fabrics, and wherein an outer layer of the protective sheathing is made of glass fibre webs wound around the metal pipe in such a way that edges of the glass fibre web partially overlap.

13. The metal pipe according to claim 1, wherein the thermoplastic coating comprises polyethylene, polypropylene, fusion-bonded epoxy (FBE) and/or polyurethane, and wherein the thermoplastic coating is provided between the corrosion protection layer and the protective sheathing.

14. The metal pipe according to claim 1, wherein the metal pipe has a nominal width of between 100 and 2500 millimeters, and wherein a thickness of the protective sheathing is between 5 and 8 millimeters.

15. The metal pipe according to claim 6, wherein all of the plurality of layers of the protective sheathing are formed by cross-wound textile glass fibres.

16. The metal pipe according to claim 15, wherein the plurality of layers of the protective sheathing are wound under tension with a tensile force F_{Z} around the steel pipe, the tensile force being adjusted as a function of the linear fibre density.

17. The metal pipe according to claim 1, wherein the combination of the corrosion protection layer, the thermoplastic coating, and the protective sheathing is configured to have a weight change of less than 20 grams per m² outer surface when tested for water absorption over a test period of 1050 hours with a specimen with a length of 25 mm.
